(19) United States
(12) Patent Application Publication
(10) Pub. No.: US 2015/0177569 A1
(43) Pub. Date: Jun. 25, 2015

(54) LIQUID CRYSTAL DISPLAY PANEL

(71) Applicant: Shenzhen China Star Optoelectronics Technology Co. Ltd., Shenzhen (CN)

(72) Inventor: Xin Zhang, Shenzhen (CN)

(21) Appl. No.: 13/704,634

(22) PCT Filed: Sep. 24, 2012
(86) PCT No.: PCT/CN12/81813

§ 371 Date: Dec. 17, 2012

(30) Foreign Application Priority Data
Sep. 3, 2012 (CN) 201210320332.9

(51) Int. Cl. G02F 1/1343; G02F 1/1368; G02F 1/1333

(52) U.S. Cl. CPC G02F 1/134309; G02F 1/133345; G02F 1/1368

(57) ABSTRACT

The present invention discloses a liquid crystal display panel, which has a scan line, a data line, a switch unit, liquid crystal molecules, and a pixel domain. The scan line and the data line are electrically connected to the switch unit. The liquid crystal display panel comprises: a pixel electrode disposed in the pixel domain, the pixel electrode being electrically connected to the switch unit; and a conductive electrode layer disposed below a peripheral region of the pixel electrode, the conductive electrode layer and the pixel electrode being separated by an insulating layer, wherein the conductive electrode layer is used to supply a voltage for forming pre-tilt angles of the liquid crystal molecules. The liquid crystal panel can solve the problem of non-uniform brightness of the display panel or dark lines occurred on said panel.

### BACKGROUND OF THE INVENTION

1. Field of the Invention

The present invention relates to a liquid crystal display (LCD) panel, and more particularly, to a LCD panel capable of solving the problem of non-uniform brightness (i.e, mura) of the display panel or dark lines occurred on said panel.

2. Description of Prior Art

A display with advanced functions is a key element for use in current consumer electronic products. The novelty and colorful displays with high resolution, e.g., LCDs, are indispensable components used in various electronic products, served as display screens for personal computers, notebook computers, personal digital assistants (PDAs), digital cameras, and mobile phones, and etc.

A LCD comprises a backlight module and a LCD panel. A traditional LCD panel comprises two substrates and a liquid crystal (LC) layer sandwiched by the two substrates. In general, an alignment film is formed on both of the two substrates during the LCD panel manufacturing process so that LC molecules can be arranged in a specific direction. In a traditional method for forming the alignment film, an alignment material is coated and then the alignment material undergoes an alignment process.

Currently, a technology called polymer stabilized vertical alignment (PSVA) has been developed in the industry. As to the PSVA technology, a LC material is mixed with monomers that have an appropriate concentration, and then the mixed LC material is shaken uniformly. Next, the mixed LC material is placed on a heater and heated until it achieves isotropy. When the mixed LC material reaches a room temperature, it tends to go back to a nematic state. Subsequently, the mixed LC material is injected into a LC cell, and a voltage is applied to the LC cell. The voltage makes the LC molecules align stably in the cell. Then, the mixed LC material is polymerized by exposing it under ultraviolet (UV) light or by heating in order to form a polymer layer. In this way, alignment stability can be carried out.

In general, for a pixel structure in a PSVA LCD panel, alignment slits formed in a pixel electrode can make the LC molecules align in a specific direction. Please refer to FIG. 1, which is an enlarged diagram of a pixel in a conventional PSVA LCD panel. As shown in FIG. 1, the LCD panel comprises a data line DL, a scan line SL, a thin-film transistor (TFT) 114, and a pixel electrode 110. The pixel electrode 110 disposed within a pixel domain has a snowflake-like pattern (or layout). The pixel electrode 110 comprises a vertical central main trunk 111, a horizontal central main trunk 112, and branches 113 slanted away from the X axis by ±45 degrees and by ±135 degrees. The vertical main trunk 111 and the horizontal main trunk 112 divide a pixel into four equal domains. The branches 113 are slanted at a 45-degree angle and are paved inside said four domains.

Therefore, a snowflake-like electrode pattern forming an upper-lower and left-right mirror-image symmetry is completed.

In this electrode pattern, a part of the branches 113 is electrically connected to the TFT 114 for transmitting the voltage from the scan line SL to the pixel electrode 110.

Please refer to FIG. 2, which illustrates an ideal alignment of the LC molecules when a constant voltage (e.g., 4 volts) is applied to the pixel electrode 110 shown in FIG. 1. As shown in FIG. 2, when the voltage is applied to the snowflake-like pixel electrode 110, the LC molecules are slanted gradually from an outer part to an inner part of the pixel electrode 110. The LC molecules are slanted along extending directions of the branches 113. The slanted angles of the LC molecules in said four domains are ±45 and ±135 degrees, respectively. The slanted LC molecules of said four domains are all directed toward a center of the pixel domain. For a detailed explanation, as shown in FIG. 2, the included angles between the slanted directions of the LC molecules and the X axis (i.e., the scan line) are respectively −135 degrees in the first quadrant, −45 degrees in the second quadrant, 45 degrees in the third quadrant, and 135 degrees in the fourth quadrant.

Please refer to FIG. 3, which is a cross-sectional view of slanted directions of the LC molecules along a dash line A-B-C shown in FIG. 2. As shown in FIG. 3, on the cross section (perpendicular to the sheet surface) along the dash line shown in FIG. 2, the LC molecules are slanted from the peripheral region to the center of the pixel electrode 110. The slanted LC molecules are directed toward the inside of the pixel.

It is notified that, in conventional PSVA processes, a voltage is applied to the LCD panel and then the LC molecules are exposed to UV light to form pre-tilt angles. In PSVA, applying the voltage for the first time is quite important for the LC alignment. No matter how the quality of the LC alignment is, the alignment will be completely memorized in LC cells once cured by UV light. Therefore, if it can make the LC molecules align as the ideal alignment shown in FIG. 2 as possible, it may be able to increase the transparence of the LCD panel and improve the display effect of the panel as well. However, the conventional pixel electrode shown in FIG. 1 cannot carry out the ideal LC alignment and expected pre-tilt angles. It may not get a good alignment for the LC molecules. Accordingly, the LCD panel may appear dark lines DR as shown in FIG. 4. The efficiency of the LCD molecules is decreased. The problem of non-uniform brightness (i.e., so-called mura) of the display panel may occur and this affect the display effect of the panel.

### SUMMARY OF THE INVENTION

An object of the present invention is to provide a liquid crystal panel for solving the problem of non-uniform brightness of the display panel or dark lines occurred on said panel.

According to embodiments of the present invention, the present invention discloses a liquid crystal display panel, which has a scan line, a data line, a switch unit, liquid crystal molecules, and a pixel domain. The scan line and the data line are electrically connected to the switch unit. The liquid crystal display panel comprises a pixel electrode disposed in the pixel domain, the pixel electrode being electrically connected to the switch unit; and a conductive electrode layer disposed below a peripheral region of the pixel electrode, the conductive electrode layer and the pixel electrode being separated by an insulating layer, wherein the conductive electrode layer is used to supply a voltage for forming pre-tilt angles of the liquid crystal molecules.

Compared to forming the pre-tilt angles of the liquid crystal molecules in conventional PSVA processes, the present invention further applies a voltage to the conductive electrode layer disposed below the peripheral region of the pixel electrode, and this improves the fringe electric filed on the pixel electrode. Accordingly, in the present invention, the liquid crystal molecules located corresponding to the peripheral region of the pixel electrode are much better in alignment. Therefore, the efficiency of the liquid crystal molecules is increased. The problem of non-uniform brightness of the display panel is solved. It is rare to find dark lines. Accordingly, the display effect is enhanced.

To make above content of the present invention more easily understood, it will be described in details by using preferred embodiments in conjunction with the appending drawings.

### BRIEF DESCRIPTION OF THE DRAWINGS

FIG. 1 is an enlarged diagram showing a pixel in a conventional PSVA LCD panel.

FIG. 2 is a diagram illustrating an ideal alignment of LC molecules when a constant voltage is applied to a pixel electrode shown in FIG. 1.

FIG. 3 is a cross-sectional view of slanted directions of LC molecules along a dash line A-B-C shown in FIG. 2.

FIG. 4 is a diagram showing an effect carried out by utilizing conventional skills.

FIG. 5 is an enlarged diagram of a pixel in an LCD panel according to a first embodiment of the present invention.

FIG. 6 is a cross-sectional view made along a dash line A-B shown in FIG. 5.

FIG. 7 is a diagram illustrating a loop-shaped conductive layer having a breach.

FIG. 8 is a diagram illustrating a loop-shaped conductive layer having a plurality of conductive members that are arranged in a loop shape.

FIG. 9 is a diagram illustrating a conductive member having a sawtooth-shaped margin.

FIG. 10 is a diagram showing an effect carried out by utilizing the present invention.

FIG. 11 is an enlarged diagram of a pixel in an LCD panel according to a second embodiment of the present invention.

FIG. 12A is a diagram showing a pixel electrode having a horizontal straight opening in the second embodiment of the present invention.

FIG. 12B is a diagram showing a pixel electrode having a vertical straight opening in the second embodiment of the present invention.

FIG. 12C is a diagram showing a pixel electrode having an X-shaped opening in the second embodiment of the present invention.

FIG. 12D is a diagram showing a pixel electrode having a snowflake-like opening in the second embodiment of the present invention.

FIG. 13A is a diagram showing a pixel electrode, in which a minimum distance between a peripheral portion of the pixel electrode and a contour of an opening is not a zero in the second embodiment of the present invention.

FIG. 13B is a diagram showing a pixel electrode having an opening that is constructed by a plurality of discontinuous openings in the second embodiment of the present invention.

FIG. 13C is a diagram showing a pixel electrode having an opening that comprises a bulk-shaped rectangular opening in the second embodiment of the present invention.

FIG. 13D is a diagram showing a pixel electrode having an opening that comprises a bulk-shaped circular opening in the second embodiment of the present invention.

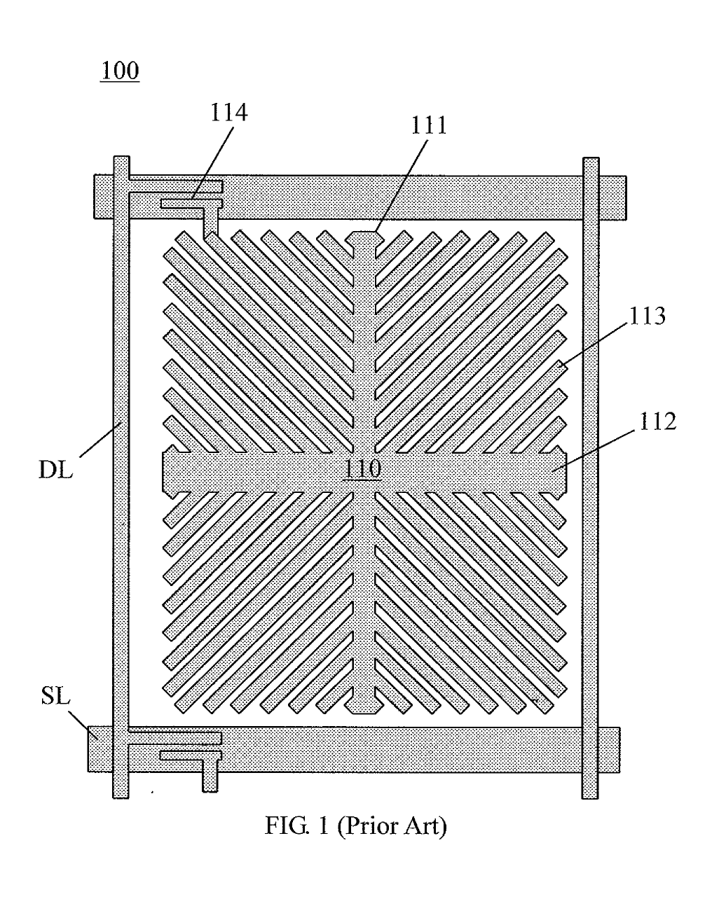

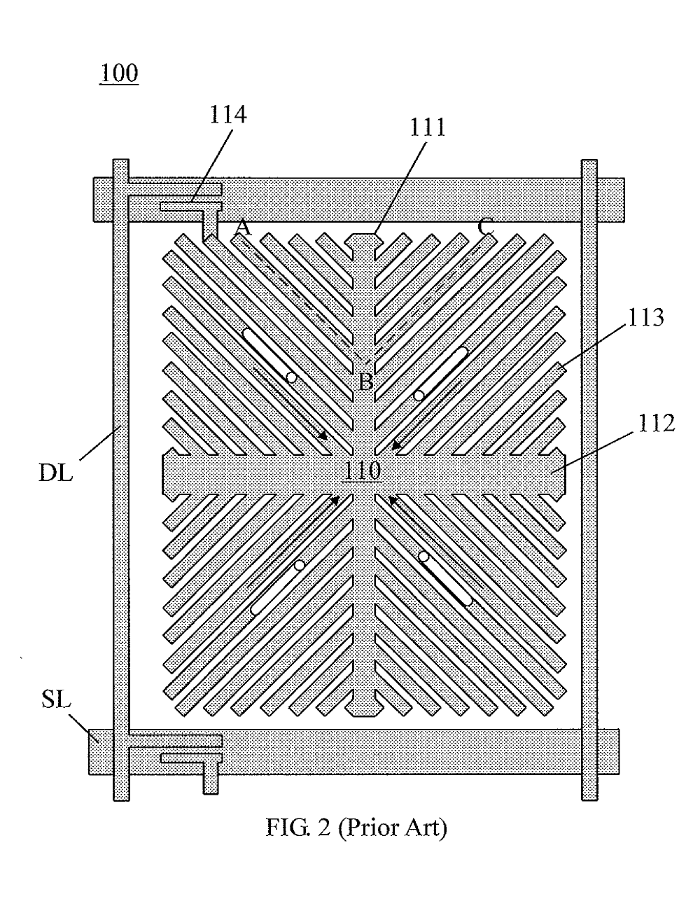

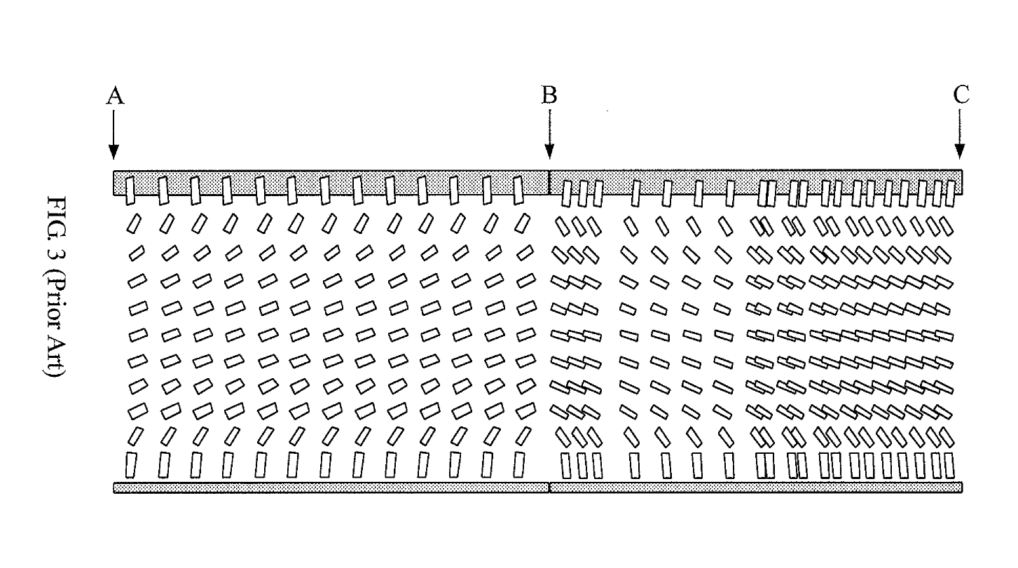

### DETAILED DESCRIPTION OF THE PREFERRED EMBODIMENTS

The following descriptions for the respective embodiments are specific embodiments capable of being implemented for illustrations of the present invention with referring to appended figures. Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

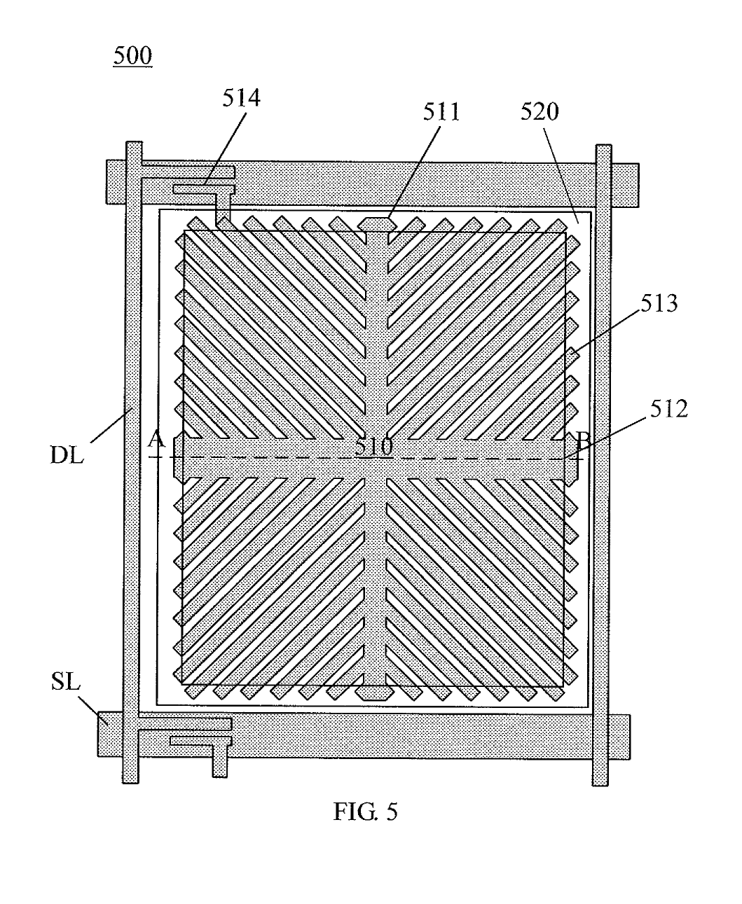

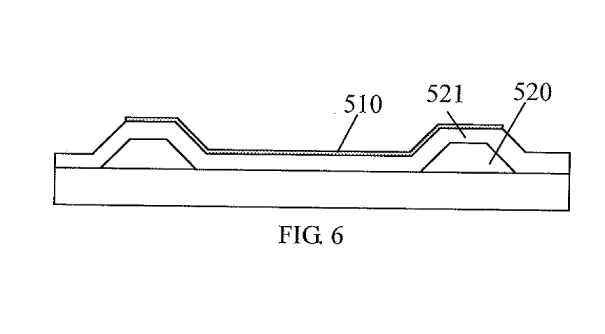

Please refer to FIG. 5 and FIG. 6. FIG. 5 is an enlarged diagram of a pixel in an LCD panel 500 according to a first embodiment of the present invention. FIG. 6 is a cross-sectional view made along a dash line A-B shown in FIG. 5. In the present embodiment, a PSVA LCD panel is taken as the LCD panel 500 for illustration. As shown in FIG. 5 and FIG. 6, the LCD panel 500 has a data line DL, a scan line SL, a switch unit 514, liquid crystal molecules (not shown), a pixel electrode 510, and a conductive electrode layer 520. Preferably, the switch unit 514 is a TFT or a unit having a similar switch function. The pixel electrode 510 is disposed in a pixel domain and is electrically connected to one terminal of the switch unit 514. Also, the switch unit 514 is electrically connected to the scan line SL and the data line DL. In this arrangement, voltages applied to the scan line SL can turn on the switch unit 514, and thereby data signals carried by the data line DL can be transmitted to the pixel electrode 510.

In the first embodiment of the present invention, the pixel electrode 510 mainly includes three parts, that is, a vertical main trunk 511, a horizontal main trunk 512, and a plurality of branches 513. The pixel electrode 510 has a snowflake-like pattern (or layout). The horizontal main trunk 512 is perpendicular to the vertical main trunk 511. The vertical main trunk 511 and the horizontal main trunk 512 divide the pixel domain into four domains. The plural branches 513 are distributed in said four domains. Each of the branches 513 is connected to the vertical main trunk 511 or the horizontal main trunk 512. For example, the plural branches 513 slanted away from the X axis by ±45 degrees and by ±135 degrees. The branches 513 slanted at a 45-degree angle are paved inside said four domains. Every neighboring two of the plural branches 513 have a same gap.

As shown in FIG. 5 and FIG. 6, the LCD panel 500 has the conductive electrode layer 520 disposed therein. The conductive electrode layer 520 also can be a metal conductive layer made of metal materials. The conductive electrode layer 520 is disposed below a peripheral region of the pixel electrode 510. The conductive electrode layer 520 and the pixel electrode 510 are separated by an insulating layer 521.

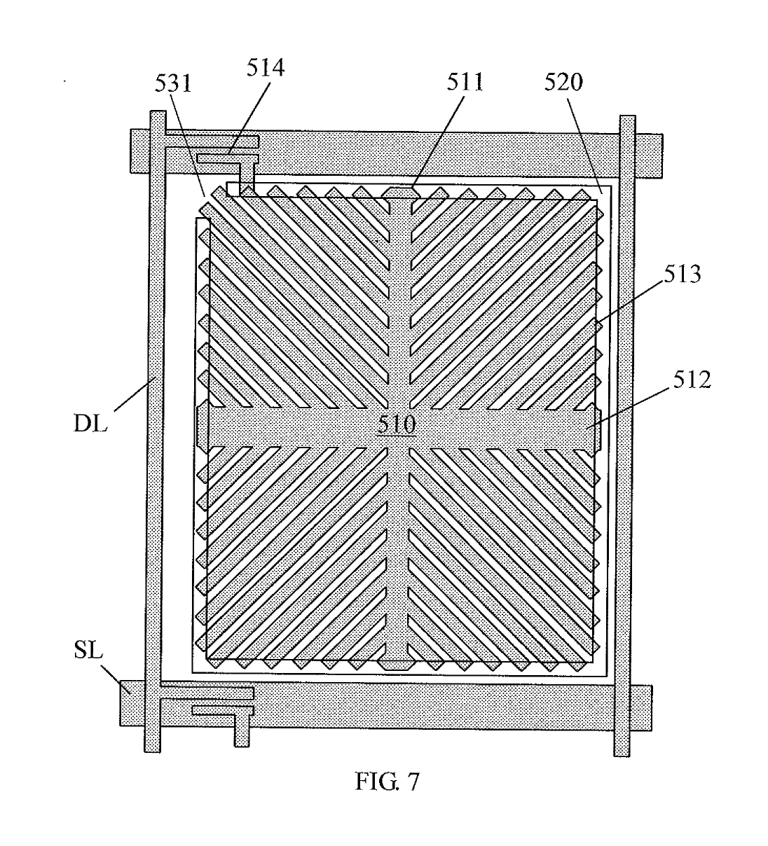

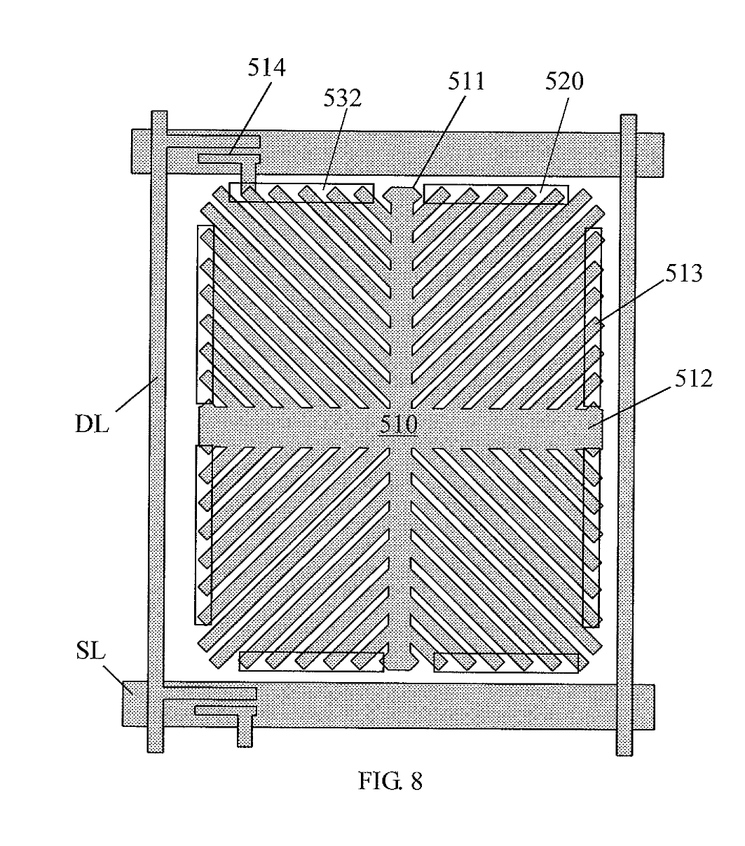

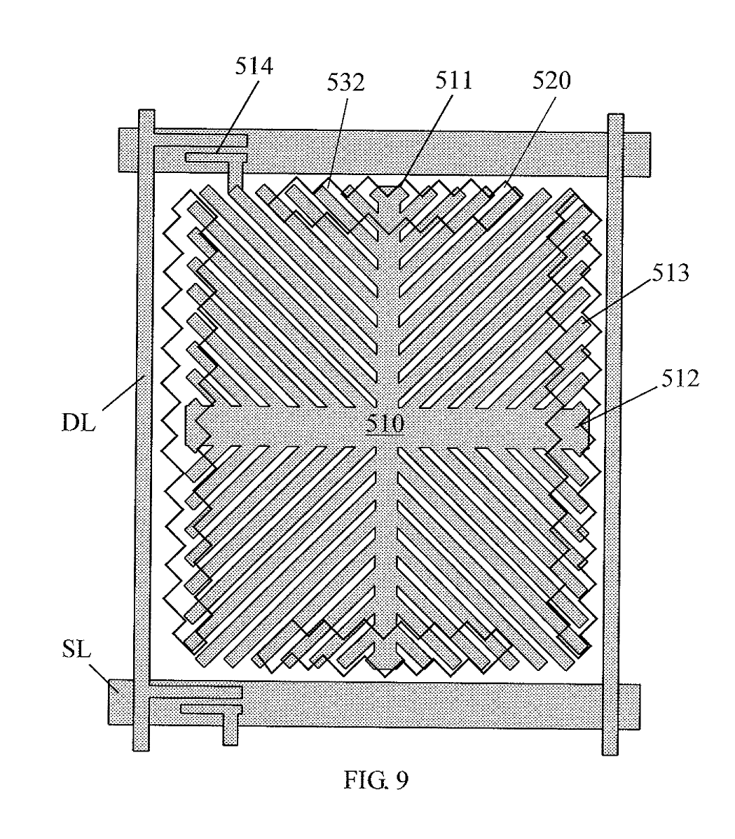

The conductive electrode layer 520 may be disposed corresponding to a contour or a shape of the pixel electrode 510. As shown in FIG. 5, the conductive electrode layer 520 can be a loop-shaped conductive layer or a rectangular loop-shaped conductive layer disposed corresponding to the contour of the pixel electrode 510. Moreover, as shown in FIG. 7, the loop-shaped conductive layer 520 may have one or more breaches 531. Alternatively, as shown in FIG. 8, the loop-shaped conductive layer 520 comprises a plurality of conductive members 532 and the plural conductive members 532 are looped with a discrete distribution. In another embodiment, each of the plural conductive members 532 of the loop-shaped conductive layer 520 may have an irregular shape, or a sawtooth-shaped margin, or any other geometric edge, as shown in FIG. 9.

In the present invention, the conductive electrode layer 520 is used in a PSVA process, in which a voltage is applied to the LCD panel and then the liquid crystal molecules are exposed to UV light to form pre-tilt angles. During forming the pre-tilt angles of the liquid crystal molecules, the present invention further applies a voltage to the conductive electrode layer 520 disposed below the peripheral region of the pixel electrode 510 in addition to applying voltages for forming an electric filed between a color filter substrate (not shown) and the pixel electrode 510. Therefore, the present invention can improve a fringe electric field on the pixel electrode 510, and thereby a better alignment of the liquid crystal molecules is obtained. For example, the liquid crystal molecules are slanted from an outer part to an inner part of the pixel electrode 510 along the branches 513. The present invention can make the alignment of the liquid crystal molecules approach to an ideal alignment. In addition, when applying a voltage to the conductive electrode layer 520, the applied voltage can be any appropriate predetermined voltage or a voltage close to or equal to a common voltage applied to the color filter substrate.

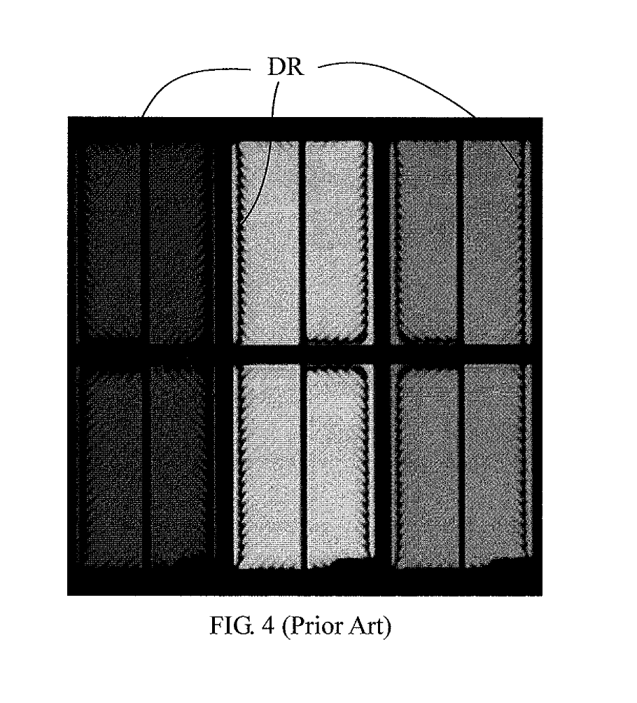

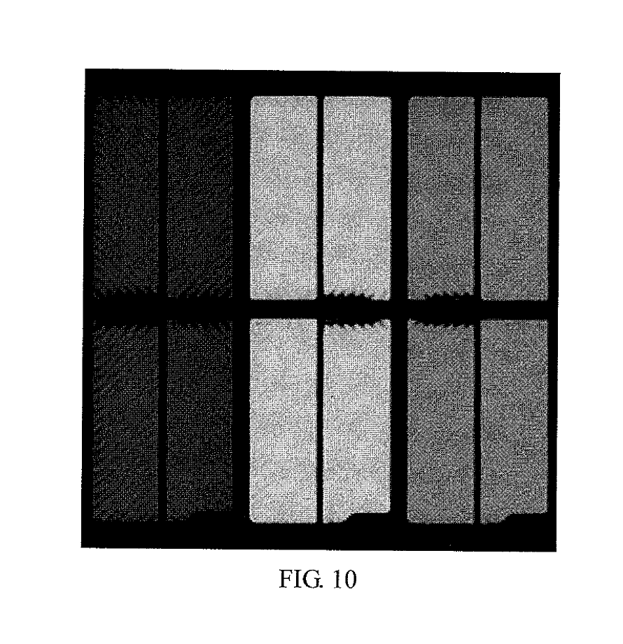

Compared to forming the pre-tilt angles of the liquid crystal molecules in conventional PSVA processes, the present invention further applies a voltage to the conductive electrode layer 520 disposed below the peripheral region of the pixel electrode 510, and this improves the fringe electric filed on the pixel electrode 510. Accordingly, in the present invention, the liquid crystal molecules located corresponding to the peripheral region of the pixel electrode 510 are much better in alignment. Therefore, the efficiency of the liquid crystal molecules is increased. The problem of non-uniform brightness (i.e., so-called mura) of the display panel is solved. It is rare to find dark lines. Accordingly, the display effect is enhanced. The product effect carried out by utilizing the present invention can be referred to FIG. 10. Compared to the effect of conventional skills as shown in FIG. 4, the present invention surely can efficiently reduce dark lines.

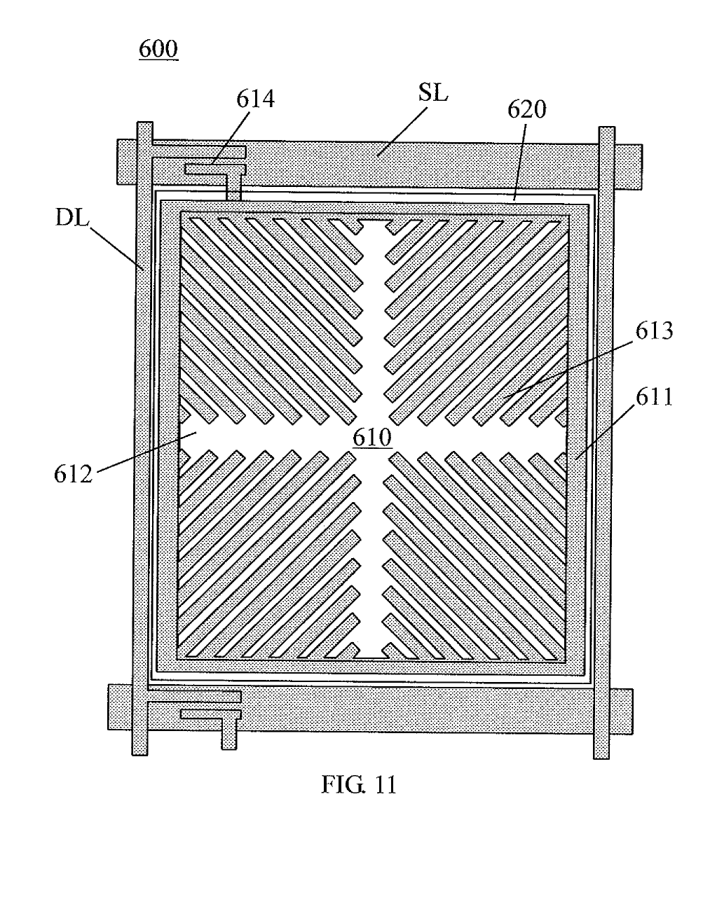

FIG. 11 is an enlarged diagram of a pixel in an LCD panel 600 according to a second embodiment of the present invention. The difference between the first embodiment and the second embodiment of the present invention is that the second embodiment makes an improvement on the pixel electrode and this can increase an aperture rate of the display panel. It is noted that as the same as the first embodiment, the LCD panel 600 of the second embodiment of the present invention also has a conductive electrode layer 620 disposed below a peripheral region of a pixel electrode and an insulating layer that separates the conductive electrode layer 620 and the pixel electrode. The modifications of the conductive electrode layer 620 of the second embodiment of the present invention can be referred to above descriptions and FIGS. 7 to 9. Related descriptions are not repeated herein.

In the second embodiment of the present invention, the LCD panel 600 can be a PSVA LCD panel. As shown in FIG. 11, the LCD panel 600 has a data line DL, a scan line SL, a switch unit 614, liquid crystal molecules (not shown), a pixel electrode 610, and the conductive electrode layer 620. The pixel electrode 610 of the second embodiment of the present invention comprises a rectangular (or square) peripheral portion 611 and a plurality of branches 613 surrounded by the peripheral portion 611. At least one opening 612 is located inside a region surrounded by the peripheral portion 611. For example, the opening 612 is located at a center of pixel electrode 610. For example, the opening 612 is profiled as a cross. The cross-shaped opening 612 divides the pixel electrode 610 into four roughly equal domains. The plural branches 613 are slanted at a 45-degree angle and are paved within said four domains. The plural branches 613 of said four domains have their individual directions. For example, the included angles between each of the branches 613 in said four domains and the X axis (e.g., the scan line SL) are ±45 degrees and ±135 degrees, respectively. In a preferred embodiment, all of the branches 613 are directed toward a center of the pixel domain. In addition, every neighboring two of the branches 613 have a same gap.

The peripheral portion 611 is electrically connected to one terminal of the switch unit 614. Also, the switch unit 614 is electrically connected to the scan line SL and the data line DL. In this arrangement, voltages applied to the scan line SL can turn on the switch unit 614. Also, by means of the conduction of the switch unit 614 and the peripheral portion 611, data signals carried by the data line DL can be transmitted to the pixel electrode 610.

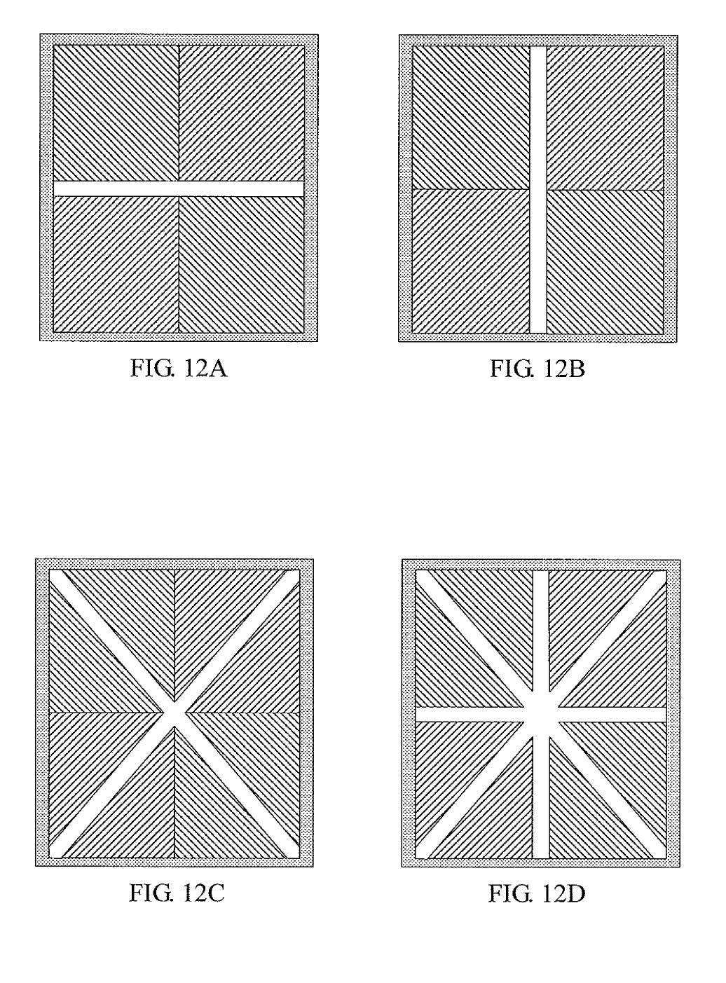

The opening 612 also can be profiled as a straight line parallel to the scan line SL (as shown in FIG. 12A) or a straight line parallel to the data line DL (as shown in FIG. 12B). In practical applications, the opening 612 also can be profiled as an X-shaped opening (as shown in FIG. 12C) that divides the plural branches 613 into four domains or be profiled as a snowflake (as shown in FIG. 12D) that divides the plural branches 613 into eight domains.

Moreover, it is notified that, although the peripheral portion 611 is shaped as a rectangular frame as illustrated in afore-mentioned embodiments, it can be shaped as a circle, a hexagon, an octagon, or any other shape in practical applications. In other words, the peripheral portion 611 is not restricted to being a rectangle.

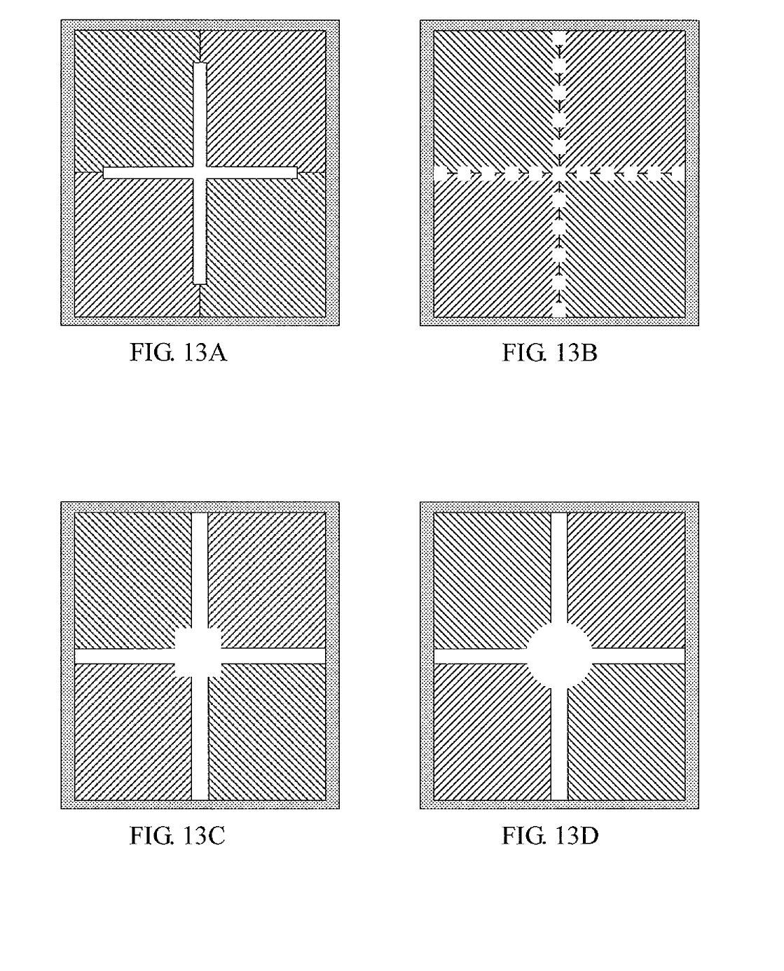

In one embodiment, a minimum distance between the peripheral portion 611 and a contour of the opening 612 is not a zero (as shown in FIG. 13A). In one embodiment, the opening 612 is constructed by a plurality of discontinuous openings (as shown in FIG. 13B). In one embodiment, the opening 612 comprises a bulk-shaped opening located at a center of the pixel electrode 610. The bulk-shaped opening is selected from a group consisting of a triangle, a rectangle (shown in FIG. 13C), a star shape, a circle (shown in FIG. 13D), an ellipse, and a regular polygon.

In the second embodiment of the present invention, an area occupied by non-opening regions can be decreased dramatically. The pixel electrode of the second embodiment has a larger light transmittable area, thereby providing a higher aperture rate.

Above all, although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

What is claimed is:

1. A liquid crystal display panel, having a scan line, a data line, a switch unit, liquid crystal molecules, and a pixel domain, the scan line and ₜhe data line being electrically connected to the switch unit, said liquid crystal display panel comprising:
a pixel electrode disposed in the pixel domain, the pixel electrode being electrically connected to the switch unit; and
a conductive electrode layer disposed below a peripheral region of the pixel electrode, the conductive electrode layer and the pixel electrode being separated by an insulating layer, wherein the conductive electrode layer is used to supply a voltage for forming pre-tilt angles of the liquid crystal molecules.

2. The liquid crystal display panel according to claim 1, wherein the conductive electrode layer is a loop-shaped conductive layer.

3. The liquid crystal display panel according to claim 2, wherein the loop-shaped conductive layer has a breach.

4. The liquid crystal display panel according to claim 2, wherein the loop-shaped conductive layer comprises a plurality of conductive members and the plural conductive members are looped with a discrete distribution.

5. The liquid crystal display panel according to claim 4, wherein each of the conductive members has a sawtooth-shaped margin.

6. The liquid crystal display panel according to claim 1, wherein the conductive electrode layer is a metal conductive layer.

7. The liquid crystal display panel according to claim 1, wherein the pixel electrode comprises:
a vertical main trunk;
a horizontal main trunk perpendicular to the vertical main trunk, the vertical main trunk and the horizontal main trunk dividing the pixel domain into four domains; and
a plurality of branches distributed in said four domains, each of the branches is connected to the vertical main trunk or the horizontal main trunk.

8. The liquid crystal display panel according to claim 7, wherein every neighboring two of the plural branches have a same gap.

9. The liquid crystal display panel according to claim 1, wherein the pixel electrode comprises:
a peripheral portion electrically connected to one terminal of the switch unit;
a plurality of branches surrounded by the peripheral portion, the plural branches being connected to the peripheral portion; and
at least one opening located inside a region surrounded by the peripheral portion, the opening dividing the plural branches into at least two domains.

10. The liquid crystal display panel according to claim 9, wherein the peripheral portion is shaped as a rectangle.

11. The liquid crystal display panel according to claim 9, wherein the opening is profiled as a cross, which divides the plural branches into four domains.

12. The liquid crystal display panel according to claim 9, wherein the opening is profiled as a straight line, which is parallel to the scan line.

13. The liquid crystal display panel according to claim 9, wherein the opening is profiled as a straight line, which is parallel to the data line.

14. The liquid crystal display panel according to claim 9, wherein the opening is profiled as an X-shaped opening, which divides the plural branches into four domains.

15. The liquid crystal display panel according to claim 9, wherein the opening is profiled as a snowflake, which divides the plural branches into eight domains.

16. The liquid crystal display panel according to claim 9, wherein the opening comprises a bulk-shaped opening located at a center of the pixel electrode.

17. The liquid crystal display panel according to claim 16, wherein the bulk-shaped opening is selected from a group consisting of a triangle, a rectangle, a star shape, a circle, an ellipse, and a regular polygon.

18. The liquid crystal display panel according to claim 9, wherein a minimum distance between the peripheral portion and a contour of the opening is not a zero.

19. The liquid crystal display panel according to claim 9, wherein the opening is constructed by a plurality of discontinuous openings.

20. The liquid crystal display panel according to claim 9, wherein every neighboring two of the plural branches have a same gap.
